(19) United States
(12) Patent Application Publication
(10) Pub. No.: US 2025/0050587 A1
(43) Pub. Date: Feb. 13, 2025

(54) METHOD AND DEVICE FOR ADDITIVELY MANUFACTURING A COMPONENT

(71) Applicant: PERI SE, Weissenhorn (DE)

(72) Inventor: Yulia Kondrakova, Weissenhorn (DE)

(73) Assignee: PERI SE, Weissenhorn (DE)

(21) Appl. No.: 18/798,383

(22) Filed: Aug. 8, 2024

(30) Foreign Application Priority Data
Aug. 10, 2023 (DE) 10 2023 121 405.5

(51) Int. Cl. B29C 64/393; B33Y 10/00; B33Y 30/00; B33Y 50/02

(52) U.S. Cl. CPC B29C 64/393; B33Y 10/00; B33Y 30/00; B33Y 50/02

(57) ABSTRACT

A device and a method for additively manufacturing a component, wherein the manufactured component has at least two component portions neighboring in a horizontal plane, which are adjacent to one another in at least one connection region; comprising the steps of: planning the at least one connection region of the component portions adjacent to one another; controlling a material dispensing unit for depositing a building material; and controlling an actuator assembly which is designed to move the material dispensing unit over a work surface in order to deposit the building material layer by layer in predetermined print paths.

### RELATED APPLICATIONS

This application claims priority to German Patent Application No. 10 2023 121 405.5, filed Aug. 10, 2023, which is hereby incorporated by reference.

### FIELD

The invention relates to a method for additively manufacturing a component having at least two component portions adjacent to one another. The invention also relates to a device for additively manufacturing a component having at least two component portions adjacent to one another, comprising a material dispensing unit for depositing a building material and an actuator assembly which is designed to move the material dispensing unit over a work surface in order to deposit the building material layer by layer in predetermined print paths.

### BACKGROUND

Methods and devices for additively manufacturing three-dimensional objects are well known for producing models, prototypes, tools, and end products, for example. In this case, starting materials or building materials in the form of liquids, powders, or filaments made of thermoplastic plastics are deposited by a print head fastened to an end effector of an actuator assembly in order to build up the object in layers based upon 3D data of the object to be manufactured. Such a method is also referred to, inter alia, as a “generative manufacturing method” or as “3-D printing.”

In the meantime, it is also known to use additive manufacturing methods for manufacturing entire structures or parts of structures (for example, walls or formwork). The additive manufacturing of components or of entire structures can significantly increase productivity in the construction industry. As a result of so-called “3D concrete printing”, structures can be produced faster and at lower costs. With the aid of a 3D concrete printer, concrete structures can be realized quickly and economically, while at the same time having maximum design freedom.

3-D concrete printers are regularly provided in the so-called portal design. The material dispensing unit or print head is attached to a crossbeam, which in turn runs between two parallel horizontal beams above a work surface. The material dispensing unit is movable along the longitudinal axis of the crossbeam, wherein the crossbeam is also able to move back and forth along the longitudinal axis of the horizontal beams. In this way, a horizontal movement parallel to the work surface in the provided print paths is possible. In order to also realize a vertical movement, the horizontal beams are connected in a vertically movable manner to corresponding vertical struts which form a vertical guide rail. Due to the mentioned structure, the material dispensing unit can move in all three spatial directions and produce building structures additively.

In order to supply the material dispensing unit with the building material to be deposited, a feed line is required, which is generally a flexible hose (hereinafter also referred to as “conveying hose”).

In the conventional design without so-called 3D concrete printers, formwork systems are usually used for producing concrete components. The frame formwork elements are arranged relative to one another and fixed in such a way that they form a mold into which a hardenable building material, i.e. an initially liquid and then hardening building material, in most cases concrete, is introduced for the production of a component. After hardening of the building material, the frame formwork elements are generally removed. This known method makes it possible to produce very fine and smooth surfaces of the concrete components in that, for example, the frame formwork elements have a corresponding surface on the formwork skin. However, this conventional design at the same time has the disadvantage that the construction of the formwork system and the subsequent dismantling are complicated and expensive.

In contrast, so-called 3D concrete printing offers the possibility of shaping corresponding components or entire structures without constructing and dismantling an additional formwork system. The building material is applied in individual layers.

In practice, it has been shown that an optimal bond of the individual printing layers and a uniform layer width of the print path layers layered on top of one another depends to a significant extent on the printing speed, in particular on the time interval between the dispensing of a first print path layer and of a second print path layer layered on top thereof. Studies have shown that, for a good bond, the first or lower print path layer must already be sufficiently cooled to support the subsequent second print path layer. At the same time, however, it should not have cooled too much, since, otherwise, a sufficient bond between the print path layers layered on top of one another cannot be achieved and the structure may collapse as a result.

The print quality of the individual print path layers also depends on both the dispensing speed with which the building material is dispensed and the travel speed with which the material dispensing unit is moved or travels over the work surface. For optimum density and width of the print path layers, the dispensing speed and the travel speed must be coordinated. If the travel speed is too high without a corresponding adjustment of the dispensing speed, an increased porosity of the print path layer is, for example, to be expected, and the layer width decreases unless the dispensing of the building material is also accelerated.

The above-mentioned factors of an optimal bond of the print path layers and an optimal print quality of the individual print path layers also result in a maximum print path length for an optimal quality and strength of the printing result in the planning of the print paths.

Furthermore, the high costs of the portal design for very large-scale printing projects pose challenges for the 3D printing of large structures. For example, enlarging the printing system leads to a significant increase in system costs and, at the same time, to increased complexity in the structure of the system.

A solution to these known problems, which is obvious at first glance, is to manufacture or print a component in several component portions.

A new difficulty which results directly therefrom and has so far opposed this solution is the bonding of the separately printed component portions to one another or together.

For example, a first printed component portion represents an obstacle for the material dispensing unit when the latter is to print an adjacent component portion.

In order not to damage the first component portion when printing the second component portion, a significant distance is therefore left in practice between the component portions, as described, for example, in publication PL 238057 B1.

Publication PL 238057 B1 describes a method for connecting wall parts that were manufactured separately from one another. In doing so, the end portions of the neighboring wall parts are connected by subsequently filling the gap between the wall parts with building material. The technically required gap between the neighboring wall parts, which results from the fact that the print head has to keep a distance from the already printed first wall part when printing the second wall part, is laterally limited by heating plates, comparably to heated panel formwork elements. By additionally heating the lateral heating plates, temperature differences between the two wall parts to be connected can be compensated and unwanted stresses can be reduced.

Publication U.S. Pat. No. 10,639,844 B2 discloses a method for additively manufacturing a multi-part component, wherein first a first component portion and then a second component portion are manufactured separately from one another, which are subsequently connected to one another, for example via a form-fitting connection structure, and are cured together.

The individual component portions are thus first manufactured in a manner completely detached from one another, like puzzle pieces, then brought into contact with one another and, if necessary, connected to one another via a form fit in order to cure together. The process of connecting the not yet cured component portions thus represents a significant challenge in terms of process technology. Furthermore, this patent proposes in preparation for contacting to wet the contact points (“washing”), which further increases the associated effort.

Publication CN104328845 furthermore discloses a solution in which two components of a reinforced wall are produced independently of one another, and the wall parts are then reinforced by means of 3D printing. In this solution, stiffening elements, such as metal bars, are inserted into pre-formed recesses of the wall parts and used to connect the neighboring wall parts.

First, a first wall part and a second wall part of the reinforced wall are produced using 3D printing technology. In this case, the end part of the first wall part and the end part of the second wall part each form a butt joint slot. Horizontal steel bars are anchored in the first wall part and in the second wall part, and one end of each horizontal steel bar projects into the corresponding butt joint slot and forms a so-called anchoring end.

Furthermore, the butt connection slot of the first wall part and the butt connection slot of the second wall part are arranged in a butt connection manner in order to form a butt connection space. Vertical steel bars are inserted at intervals in the first wall part, the butt connection space, and the second wall part.

In order finally to form a reinforced 3D-printed wall, concrete is cast into the first wall part, the butt connection space, and the second wall part. The connection method and the connection structure for the 3D-printed shear wall made of reinforced masonry are to ensure earthquake-proof properties and thermal insulation properties of the 3D-printed wall.

Furthermore, it is known from the prior art to manufacture components in multiple parts, in particular with a support structure to be removed later. In this respect, reference is made to WO 2019/241286 A1.

The known solutions show that the connection of individual component portions requires complex and cost-intensive solutions and post-processing steps.

### SUMMARY

In contrast, an object of the present invention is to provide a simple solution for additively manufacturing multi-part components.

The object is achieved by a method. Furthermore, the present invention proposes a device for achieving the object.

The dependent claims and the features described below relate to advantageous embodiments and variants of the invention.

A method for additively manufacturing a component is provided, preferably for additively manufacturing structures or components of structures on a work surface or a substrate.

The component to be manufactured can in particular be part of a structure or a formwork. The component can also be a complete structure or a complete formwork. In principle, any components can be manufactured additively with the method according to the invention.

In the context of the invention, building structures can be understood as structures of all types, in particular however protective structures such as buildings for the accommodation and stay of humans or animals, protective walls, dikes, shelters, enclosures, weirs and fortification systems, and city walls and prison walls. However, a structure can also be a traffic structure, for example a road, a pedestrian pathway, a bridge or a tunnel. Supply and disposal structures such as wells, sewage treatment plants, dams, chimneys or temporary structures can also be manufactured additively within the scope of the invention.

Within the scope of the invention, a component of a structure can in particular be a functional component of a structure, in particular a functional or geometrically cohesive part of the structure such as a wall, a support, or a stair. A building part consisting of multiple components of the structure (for example a floor or a story of a building) can also fall under the term “component” within the scope of the invention. A formwork or formwork component can also be a component within the scope of the invention, in particular if the formwork component or the formwork subsequently forms a part of the structure, for example the outer part of a wall of the building.

Multiple components can also be produced using the proposed method, possibly also components that are not connected to one another.

However, the special feature of the solution according to the invention is that the component is printed in several component portions, for example in two component portions which are neighboring in a horizontal plane and adjacent to one another in at least one connection region.

The term “adjacent to one another” includes the fact that the component portions which are neighboring in a horizontal plane are directly adjacent to one another, i.e., they may also merge into one another.

However, in the sense of the present invention, solutions are also to be included in which a slight gap remains in the at least one connection region between the component portions, which gap is, however, smaller than in additive manufacturing without the use of the method according to the invention or the device according to the invention.

It is known that the solutions already available on the market leave at least a horizontal gap in the region of the connection point of two separately printed component portions. As already explained above in connection with, for example, the disclosure of PL 23 80 57 B1, this is due to the fact that, in additive manufacturing, damage to already printed component portions as a result of a collision with the material dispensing unit is to be avoided. This results in a minimum gap between the component portions which are neighboring in one plane, which gap can be reduced in the sense of the term “adjacent to one another” with the aid of the present invention.

According to the invention, the method comprises the steps of: planning the at least one connection region of the component portions adjacent to one another; controlling a material dispensing unit for depositing a building material; and controlling an actuator assembly which is designed to move the material dispensing unit over a work surface in order to deposit the building material layer by layer in predetermined print paths.

In this way, first at least two print path layers, layered on top of one another, of a first of the at least two component portions adjacent to one another and then at least one print path layer of a second of the at least two component portions adjacent to one another in a horizontal plane are printed.

In particular, it can be provided that the material dispensing unit is designed to deposit flowable concrete (“fresh concrete”) or mortar or dry mortar as a building material.

Preferably, a concrete formulation with small aggregate is sought. In particular, a concrete can be provided which rapidly sets and in particular has a high green strength. It can also be provided that the concrete has one or more additives, for example in order to prevent excessively rapid drying in order to increase the pumpability and/or to modify the color.

For example, an aggregate of up to 10 mm or more, preferably of up to 6 mm, particularly preferably of up to 4 mm can be provided.

As an alternative to the use of concrete or mortar as a building material, however, any other building material can also be provided which can be suitable for manufacturing or building structures or components thereof, in particular polymer concrete, gypsum, clay, a plastic, preferably a thermoplastic, but also metals or alloys. In principle, any building materials can be provided within the scope of the invention.

In principle, the component can be produced from one, two, three, four or even more starting materials or building materials. For example, various concrete mixtures, plastics, metals and/or alloys can be combined with one another as desired. Accordingly, the component portions can also, in principle, be manufactured from different starting materials or building materials. If they are actually to be connected to one another in the connection region, care must be taken when selecting the possibly different starting materials or building materials to ensure that they can be connected to one another.

The material dispensing unit can be designed to dispense the building material in a defined shape, for example in print path layers with rectangular or round edges. The individual print path layers can, for example, be dispensed with a rectangular (square or elongate), round or oval cross-section. The material output unit preferably outputs the building material in the provided wall thickness of the component to be printed.

The material dispensing unit may have a dispensing opening in order to dispense the building material. The dispensing opening can have different geometries that determine how the building material is deposited, for example with a round cross-section or a rectangular cross-section. A printing normal of the material dispensing unit as a normal to the work surface runs through the dispensing opening and can be arranged parallel to a longitudinal axis of the material dispensing unit or can coincide therewith.

Furthermore, the material dispensing unit (also referred to as a print head) can, in a known manner, have a so-called hopper for receiving the supplied building material as well as a nozzle which encloses the dispensing opening and predetermines the shape of the dispensed print path layers. In one conceivable embodiment, the nozzle can be exchangeable and movable relative to the hopper, in particular rotatable about the longitudinal axis of the material dispensing unit. In an alternative embodiment, the nozzle can also be formed as an integral part of the material dispensing unit and define a dispensing opening. Regardless of the design of the nozzle, the dispensing opening defines the proximal (relative to the work surface) end of the material dispensing unit. The proximal end generally has a horizontal end surface, which is laterally limited by a radial outer edge of the proximal end.

The material dispensing unit may also comprise a series of sensor, mechanical and/or mechatronic elements that make it possible to control the material dispensing unit and parts of the material dispensing unit and/or that provide monitoring of the manufacturing process through sensors. These elements can be housed, at least partially, in a so-called e-box (electronics box) of the material dispensing unit. Furthermore, a control unit can be accommodated in the e-box and can be used to process signals from these elements and/or to control the mentioned elements.

It is understandable that all parts of the material dispensing unit that extend radially away from the printing normal may lead to a collision with existing component structures.

Accordingly, a solution known from the prior art from the company APIS COR consisted in providing a material dispensing unit with a housing part which is proximal relative to the work surface and which is designed in the manner of a tube. In the region of the tubular proximal housing part, the housing and attachments of the material dispensing unit, if provided, extend only slightly radially beyond the outer contour of the dispensing opening of the material dispensing unit. Accordingly, the gap between the component portions can advantageously be significantly reduced.

However, this also results in a large number of undesirable restrictions for the material dispensing unit and its components. In particular, this solution cannot be used for a first component portion with a large number of print path layers layered on top of one another. Instead, the length of the tubular proximal housing part limits the maximum height (the maximum number of printing layers) of the first component portion to be printed.

Accordingly, the present invention does not propose an adjustment of the material dispensing unit but rather an adjustment and thus planning of the at least one connection region of the component portions in order to avoid undesirable collisions of the material dispensing unit with an already printed component portion.

In the method according to the invention, the planning can take place either manually by a user or automatically or semi-automatically by means of or with the aid of the control unit and/or further components.

For example, the user can plan the arrangement of the print paths and in particular the print path portions manually or with the aid of typical planning tools and can pass them on as corresponding STL data or other 3D data to the control unit.

Furthermore, the control unit can, for example, be configured to convert the component data into printer data for 3D printing (or for additive manufacturing) on the basis of the STL data (or on the basis of other 3D data). For this purpose, it can be provided, inter alia, to convert the 3D data or STL data into individual layers to be printed (so-called “slicing”), after which the print paths are calculated for the individual layers in order to predetermine the movements of the material output unit. Advantageously, in the process, the building material used, environmental conditions, geometries, etc. can also be recognized and used as a basis.

Alternatively, the manually planned 3D data can also be manually converted into printer data, or the arrangement of the print path portions and connection portions can already be planned automatically by the control unit itself.

In light of the limitations described above, which inevitably result from the geometry of the material dispensing unit, the decisive factor is that the at least one connection region, i.e., the region in which the component portions are adjacent to one another in a horizontal plane, does not, as previously, form a connection point that is flush in the vertical direction, but is planned taking into account the material dispensing unit, as explained in detail below in connection with the invention.

The method furthermore comprises controlling an actuator assembly, which is designed to move the material dispensing unit over a work surface in order to deposit the building material layer by layer in predetermined print paths.

The work surface can be a substrate-in the context of the invention, in particular a subsoil and/or a foundation on which the component or structure is erected.

However, the work surface according to the invention can also be a floor of a multi-story building or a mobile, movable work surface. For example, it can be provided to transport the structure together with the work surface or substrate to its intended installation site after the additive manufacturing. Furthermore, in particular if the component portions themselves are only printed in portions up to a certain number of layers, the already printed partial portion of the respective component portion can form the work surface for a further partial portion of the component portion that is layered on top of it.

In principle, any surface on which the structure can be erected (permanently or temporarily) can be suitable as a work surface within the scope of the invention.

The print path along which the material dispensing unit deposits the building material can be calculated on the basis of 3D data of the component. Corresponding method steps are known. The 3D data of the component can in particular be three-dimensional CAD data. The component can be represented in the data in particular by point clouds, edge models, surface models and/or volume models.

Such 3D data can also be used as a basis for the manual planning by a user.

The term “printed” print path layers as mentioned within the scope of the following description of the planning of the connection region is understood to mean not actually printed print path layers, but rather the print path layers of a component portion which, according to the planning, should already be printed when a subsequent component portion is to be printed.

It is possible to provide a control unit which controls and/or regulates the method or individual method steps according to the present invention, for example the control of the material dispensing unit for depositing a building material and/or the control of the actuator assembly which is designed to move the material dispensing unit over a work surface in order to deposit the building material layer by layer in predetermined print paths.

For example, the control unit can be configured to calculate the print path on the basis of the input 3D data. The control unit can, for example, be configured to calculate a virtual model of the component in the known STL format (“standard triangulation/tessellation language” format) or STEP format (“standard for the exchange of product model data” format) from the 3D data of the component.

Taking into account the at least one planned connection region, the control unit can, in particular, also adjust the structure of the print paths and print path layers in the connection region. In the context of the STL format, the component data can be described with the aid of triangular facets. The principle is known and will therefore not be described in more detail.

An STL interface is a standard interface of many CAD systems. In the present case, the control unit can be configured to first calculate STL data for further processing from any 3D CAD data. However, the control unit can also be configured to record and further process 3D data in the STL format. In principle, any other data format can also be provided.

Regardless of whether the STL data were generated by the control unit itself or only transmitted to it, the control unit can be configured to convert the component data into printer data for 3D printing (or for additive manufacturing) on the basis of the STL data (or on the basis of other 3D data).

The control unit can therefore be configured to control the material dispensing unit depending on the print paths and/or to regulate the dispensing or depositing of the building material. Accordingly, the control unit can also be configured to control the actuator assembly, or an additional control unit can be provided for controlling the actuator assembly.

The actuator assembly can be configured to move the material dispensing unit relative to the work surface, in particular above or over the work surface, and preferably in parallel with and/or orthogonally to the work surface. The actuator assembly can also be configured to move the material dispensing unit vertically relative to the work surface, i.e. to determine the height of the material dispensing unit relative to the work surface. Finally, the actuator assembly can ensure a horizontal and/or vertical movement of the material dispensing unit by moving the material dispensing unit along correspondingly oriented guides (in particular the horizontal guides mentioned below and the vertical guide).

Insofar as the invention refers to a “vertical” or “horizontal” direction, the vertical direction is to be understood in relation to the perpendicular to the substrate or to the work surface, and the horizontal direction at right angles thereto, subject to angular deviations that result from tolerances or practical conditions of use and that do not impair the execution of the method in a disruptive manner.

For the movement of the material dispensing unit by means of the actuator assembly, one or more actuators can be provided, which can be controlled accordingly, individually or in groups, by the already mentioned control unit, for example. Manual actuation up to a purely manual initiation of movement can also be provided-if necessary, in this case, it is even possible to dispense with actuators, wherein the actuators can also be designed to support the manually/mechanically initiated movement.

In particular, the actuator assembly has at least a first horizontal guide and a second horizontal guide for the movement of the material dispensing unit. The second horizontal guide has at least one end portion (in particular at least one end) via which it is connected to the first horizontal guide. The second horizontal guide can be moved along the first horizontal guide.

It can also be provided that the material dispensing unit can be moved transversely to the first horizontal guide along the second horizontal guide.

The material dispensing unit can advantageously be moved in at least two translational degrees of freedom in order to discharge the building material. Through the possibility of movement along two translational degrees of freedom, for example a straight-running wall of a structure can be manufactured additively or layer by layer.

The material dispensing unit can be movable directly or immediately along the first and/or second horizontal guide, for example in the manner of a carriage or a trolley that runs along the corresponding horizontal guide. However, the material dispensing unit can also be moved indirectly or in mediated fashion along the corresponding horizontal guide, for example by moving it directly along any other guide, which in turn is fastened to the corresponding horizontal guide in a directly or indirectly movable manner. For example, the second horizontal guide can be moved directly along the first horizontal guide, to which the material dispensing unit is indirectly or directly fastened (e.g. in the manner of a carriage or a trolley), so that the movement of the second horizontal guide along the first horizontal guide moves the material dispensing unit along the first horizontal guide, as it were.

Furthermore, the device can have a feed position for a flexible feed line, which can be connected to the material dispensing unit, for the building material. The flexible feed line can, for example, be a conveying hose for the building material or can be the building material in fibrous form (in particular as a filament), which conveys the building material into the hopper of the material dispensing unit.

The actuator assembly for moving the material dispensing unit can have a vertical guide along which the material dispensing unit can be moved vertically to the work surface (directly or indirectly, for example via a movement of the first horizontal guide).

However, it can preferably be provided that the material dispensing unit can be moved in all three translational degrees of freedom in order to discharge the building material. In particular, a material dispensing unit movable along all translational degrees of freedom enables a flexible manufacture of any desired three-dimensional structures on the work surface.

Preferably, the material dispensing unit is moved in at least four degrees of freedom, in particular in all three translational degrees of freedom and at least one rotational degree of freedom. Particularly preferably, a movement along five degrees of freedom (preferably all three translational degrees of freedom and at least two rotational degrees of freedom) and very particularly preferably along all six degrees of freedom can be provided.

In particular if the material output unit is movable in all translational degrees of freedom and in addition in one or more rotational degrees of freedom, the individual print paths can be deposited with the greatest flexibility. In this way, the geometry of the structure or of the component can be predetermined in nearly any manner desired.

For example, a rotation of the material dispensing unit (or of a part of the material dispensing unit) can be provided during the deposition of the building material.

It can be provided that the material dispensing unit be fastened to an end effector of the actuator assembly and be moved along the print path by the actuator assembly. Preferably, here the end effector is designed as a trolley of an actuator assembly designed as a gantry crane unit and can be moved vertically along the vertical guide (preferably indirectly, by moving the horizontal guide(s) along the vertical guide). Such a system is also known under the term “portal printer”.

It should be mentioned at this point that the actuator assembly can, in principle, also be a robot or robot arm, in particular an industrial robot. For example, a six-axis robot or another movement system, e.g., a hexapod or a five-axis system, or a combination of several movement units can be provided in order to move the material dispensing unit horizontally and/or vertically. Pivotable and/or telescopically extendable movement units and/or cable systems can also be provided for forming the actuator assembly.

Even in these designs, it may be useful to adjust the print path layers and plan the at least one connection region between two component portions in order to avoid a collision of the material dispensing unit with already printed component portions.

However, the application of the method according to the invention in connection with portal printers is particularly advantageous since the known advantages of a portal printer, in particular for the additive manufacturing of large components, can be combined with the increased available component size through the division into several component portions.

The specific design of the device is not essential within the scope of the invention.

The method according to the invention can advantageously be applied to existing devices. In addition, the features according to the invention of a device according to the invention can also be retrofitted into an existing device.

According to the invention, first at least two print path layers, layered on top of one another, of a first of the at least two component portions adjacent to one another and then at least one print path layer of a second of the at least two component portions adjacent to one another are deposited.

In this way, an optimized print path length of the print paths of the component portion for an optimal connection of the print path layers, layered on top of one another, of a component portion to one another can be selected, regardless of the overall size of the component to be manufactured.

Of course, several component portions, i.e., more than two component portions neighboring in a horizontal plane, can together form the component to be manufactured. Accordingly, several connection regions can also be provided.

If reference is made within the scope of the present description and claims to a “first” component portion and a “second” component portion, this is only intended to clarify the printing order, i.e., a first component portion is already printed before a second component portion or is to be printed before a second component portion according to the planning. Thus, the statements are of course also applicable throughout to further component portions, such as a “third” component portion, a “fourth” component portion, or a “fifth” component portion, and are not limited to the first and second component portions.

In addition, two component portions neighboring in a horizontal plane can also be adjacent to one another in more than a single connection region.

Furthermore, the first component portion can of course also have more than two print path layers layered on top of one another. The only decisive factor is that a partial structure or a partial portion of the first component portion adjacently to which at least one print path layer of a second component portion adjacent in a horizontal plane is to be deposited has already been printed with several print path layers layered on top of one another.

According to the invention, the at least one print path layer of the second component portion has a print path portion in the at least one connection region, which print path portion is deposited by the material dispensing unit adjacently to a print path portion of a corresponding print path layer of the first component portion so that the corresponding print path layers of the at least two component portions can be adjacent to one another in the at least one connection region. Of course, the second component portion can also have more than one print path layer.

The print path portions in the sense of the present invention are thus the portions of the print paths and print path layers which are formed in a horizontal plane adjacently to (print path) portions of print paths and print path layers of a further component portion.

In the at least one connection region, the print path layers of the first component portion can each have at least one print path portion, wherein the print path portions of the print path layers of the first component portion in the manufactured component are adjacent to print path portions of the corresponding print path layers of the second component portion. Here, the “corresponding” print path layers refer to the print path layers that are arranged at the same layer height and thus in a common horizontal plane.

A print path portion may comprise a free end of a print path layer and/or another portion of the print path layer.

In an exemplary, particularly simple embodiment, the component can have at least two single-walled component portions which are adjacent to one another at least in the region of one of their print path ends.

In an alternative exemplary embodiment, the component can have at least two component portions, each of which has print path portions which are parallel to one another and are adjacent to one another in a connection region.

This may in particular be the case if the component portions each comprise a structure that is laterally closed in the connection region, for example a lateral termination of a double wall. The floor plan can have two substantially parallel portions (which form the two walls of the double-walled structure), which are connected at the ends by a connecting web. In this case, the connection region of the at least two component portions can comprise the two connecting webs as two print path portions adjacent to one another.

It is also possible that, in a connection region, several print path portions of a print path layer of the first component portion are adjacent to one or more print path portions of a corresponding print path layer of the second component portion. This can, for example, be advantageous if the component comprises double-walled component portions that are closed laterally in the connection region but have interruptions in the print path layer, for example in order later to feed lines, cables or the like through.

Of course, mixed forms of the embodiments described by way of example are also conceivable, for example a connection of a print path portion, comprising the free end of a print path layer, to a region of a print path layer that is formed by a non-end print path portion.

A first component portion can also be adjacent to several further component portions, wherein the further component portions can be adjacent to the first component portion in different connection regions or in the same connection region.

According to the invention, at least one upper print path portion and at least one lower print path portion of the at least two print path layers, layered on top of one another, of the first component portion are layered on top of one another with a horizontal offset in such a way that a collision of the material dispensing unit with the printed print path layers of the first component portion is avoided when printing the at least one print path layer of the second component portion.

The planning of the at least one connection region comprises the planning of this horizontal offset of the at least one upper print path portion with respect to the at least one lower print path portion.

The building material is deposited layer by layer, wherein the layers or print paths applied additively on top of one another connect to one another and form a first component portion.

In the planned connection region of the component to be manufactured, in which the first component portion will be adjacent to at least one second component portion, the print path layers are not layered directly on top of one another, but the first component portion has at least one print path portion of a lower print path layer and one print path portion of a print path layer that is upper, i.e., subsequently deposited, with respect to this lower print path layer, wherein these print path layers are arranged with a horizontal offset to one another.

The horizontal offset is also formed depending on the direction in which the print path portions adjacent to one another will run relative to one another in the connection region.

Thus, if the print path portions of the first component portion and of the second component portion are to be adjacent to one another with at least one free end, a horizontal offset can be provided by making the upper print path layer shorter, i.e., the free print path end that forms the print path portion can be offset rearward in the printing direction, i.e., away from the adjacent component portion, with respect to the free print path end of a print path layer that is lower with respect thereto.

Alternatively or additionally, if the print path portions are not formed at the end, or the adjacent print path portions run in parallel with one another in portions, the print path layers of the first component portion can be layered on top of another with the print path portions with a horizontal offset, i.e., in the overhang to the rear or laterally offset with respect to the print path extension in this region.

If the print path layers are applied directly on top of one another in a vertical direction, a component portion is formed with lateral surfaces (in the case of a wall, for example, the wall surfaces) that extend substantially in the vertical direction, i.e., as a normal to the work surface. In contrast, the lateral surfaces in the region of the horizontally offset print path portions are different from one another and have an inclination or deviation from the vertical direction, i.e., from the normal to the work surface.

Regardless of the specific design of the print path portions at the end or in another region of the print paths, at least two print path layers of the first component portion can have a horizontal offset of the print path portions relative to one another. If the first component portion has more than two print path layers layered on top of one another, for example three, four, five, eight, ten or fifteen, to name just a few examples, the print path portions layered directly on top of one another can always have a horizontal offset to one another.

Alternatively, however, several of the print path portions layered directly on top of one another may also have no horizontal offset to one another in such a way that at least one horizontal offset that makes it possible to apply or dispense the print path layer(s) of the second component portion adjacently to the first component portion is provided in the already printed portion of the first component portion.

Accordingly, the at least one upper, i.e., subsequently deposited, print path portion and the at least one lower, i.e., previously deposited, print path portion of the at least two print path layers, layered on top of one another, of the first component portion, which are layered on top of one another with a horizontal offset to one another, can define a first connection contour that deviates from a normal to the work surface, when viewed in a cross-section of the at least one connection region.

The connection region can, as already indicated above, extend along the width of a print path layer, i.e., transversely to the print path extension, or along the (parallel) print path portions laterally adjacent to one another, i.e., along the print path extension in the region of the print path portions laterally adjacent to one another. A cross-section of the connection region is defined as a cutting plane that is perpendicular to the connection region.

A cross-section of the connection region is used to simplify the representation and planning of the horizontal offset when planning the connection region. In the case of complex courses of the connection region, for example in the case of two neighboring print path portions that are not straight but curved, the planning of the connection region can take place in a cross-section and then be implemented accordingly along the curved print path course (in the direction of the print path extension) in the region of the print path portions.

The connection contour can in particular be stepped, wherein one or more steps can be provided. In the case of several steps, the steps can be regular due to the horizontal offset; for example, a step can be formed in each printing layer by a correspondingly offset print path portion, or two or three or n printing layers can together form a step. Of course, the steps can also be irregularly formed, i.e., have different heights (and accordingly different numbers of layers).

Furthermore, in the case of several steps, the steps can always have the same depth and thus the same horizontal offset. However, in principle, the horizontal offset can also be designed to be variable; for example, it can be larger in higher printing layers.

Due to the different conceivable cross-sectional shapes of the dispensed printing layers, the connection contour can have differently pronounced transitions of the individual steps.

In the case of an almost round cross-section of the dispensed print path layer, the steps can rather have the shape of a circular segment when viewed in cross-section, whereas, in the case of an almost rectangular cross-section, the steps, a clearer front step edge can be visible.

An actual connection surface (the surface of the connection region) formed by the print path portions, layered on top of one another, of the first component portion can be correspondingly more angular or rounded.

In a development of the invention, it can be provided that the planning of the at least one connection region comprises the planning of a virtual collision line which, when viewed in a cross-section of the at least one connection region, encloses a first inclination angle with a normal to the work surface that is greater than 0 degrees and less than 90 degrees.

When planning the at least one connection region and the virtual collision line, further planned parameters of the additive manufacturing process can be taken into account, namely, in particular, the number of the planned printing layers of the first component portion that will already have been printed when printing the at least one print path layer of the second component portion, the planned height of the first component portion when printing the second component portion, the planned printing layer height of an individual print path layer, the planned cross-section of the print path layers, and the like.

When viewed in cross-section, the planned virtual collision line can define a free region (hereinafter referred to as a collision region) together with the normal to the work surface and a (virtual) horizontal plane lying on an upper surface of the uppermost print path layer of the first component portion. During the planning, this free region specifies the later collision space which the material dispensing unit can enter during the additive manufacturing process in order to print the second component portion without colliding with the first, already printed component portion when printing the at least one print path layer of the second component portion.

The collision region defined as part of the planning comprises a triangular surface when viewed in cross-section. In a spatial representation, the collision space would analogously be limited not by the collision line but by a collision surface which extends along the connection region and, when viewed in cross-section, comprises the collision line.

The horizontal plane, which, when viewed as a virtual plane in cross-section, lies on the upper edge of the planned uppermost print path layer, also defines the planned maximum height of the first component portion, which is why it is referred to below as the horizontal collision plane of the first component portion.

Preferably, it is provided that no portion of the first printed component portion protrudes into the so-called collision region, i.e., that the collision region remains free when printing the at least two print path layers of the first component portion.

The virtual collision line intersects the normal to the work surface and thus defines a vertex for the first inclination angle. In order to be able to dispense the print path portions of the neighboring component portions adjacently to one another with as little gap as possible or with a minimal gap (for example, of at most 50 mm, advantageously at most 30 mm, preferably at most 20 mm), the vertex of the first inclination angle at which the collision line and the normal to the work surface intersect is placed on a collision edge of the lowest or first printed print path layer of the first component portion during the planning.

As already explained above, further planned parameters of the additive manufacturing process can be taken into account in the planning of the collision line, as is also explained below using the example of the planned lowest (i.e., in the later manufacturing process, the first printed) print path layer and its collision edge as a reference point for the collision line.

Furthermore, a print path layer can have a rectangular or almost rectangular cross-section. In this case, the collision edge of a print path layer refers to an actually existing edge of the print path layer, namely, when viewed in the cross-section of the connection region, the (exposed) edge, facing the component portion to be printed, of the upper side of the lowest print path layer, or the first print path layer to be printed, of the first component portion.

Alternatively, in all cases in which a print path layer may already not have a rectangular but a (slightly) rounded cross-section in the planning data, the collision edge of a print path layer refers to a virtual edge that is defined by an intersection line between a horizontal plane that lies horizontally on the upper side of the print path layer (horizontal collision plane of the print path layer) and a vertical plane that lies vertically on the side of the lower print path layer that faces the further component portion to be printed (vertical collision plane of the print path layer).

In the cases in which two or more print path layers layered on top of one another are to be or are dispensed on top of one another substantially without a horizontal offset to one another, the respective edges of the print path layers are not exposed but are substantially flush with the edges of the subsequently or previously printed print path layers. Thus, only the print path layer that provides an edge exposed by the horizontal offset on the connection contour has a collision edge within the meaning of the present definition.

The vertical collision plane can furthermore lie against a free end of a print path layer if the print path portions are to be dispensed with their free ends adjacent to one another. Alternatively, the vertical collision plane can also lie laterally against a side surface of a print path layer if the print path portions are dispensed in parallel with and adjacently to one another.

If only one horizontal offset and thus only one step is to be provided in a connection contour, the collision line intersects the connection contour in the collision edge of the first printed print path layer and in the further collision edge of one of the subsequent upper print path layers.

In particular, if more than one horizontal offset and thus more than one step are provided in the connection contour, the steps of the connection contour can be regular in height and depth or irregular. Thus, for a regular gradation, the horizontal offset can always be of the same size and the number of the print path layers between the horizontally offset print path portions can always be the same. For example, in each print path layer, a horizontally offset print path portion can be applied onto the print path portion of the lower print path layer, or in every second, third or nth print path layer.

In this design variant with regular gradation, the collision line lies against all steps of the connection contour.

In an alternative design with an irregular gradation, for example if the print path layers are to be dispensed with a differently sized horizontal offset and/or with a different number of print path layers between the horizontally offset print path portions, the collision line lies against the collision edge of the lowest or first print path layer and at least against one further collision edge of one or more subsequent print path layers.

In order to ascertain the contact points of the collision edge, it can therefore be provided, regardless of the specific design of the connection contour, that the collision line intersects the normal to the work surface on the collision edge of the lowest or first print path layer and the intersection point virtually forms a center of rotation for the collision line.

The collision line is rotatable about this center of rotation and lies against a further collision edge of the connection contour, namely, against the collision edge that protrudes furthest in the direction toward the collision space. In this way, it is ensured that no further step and thus no part or portion of the print path layers of the first component portion projects into the collision space.

In a development of the invention, the first inclination angle of the collision line can be greater than 5 degrees and less than 80 degrees.

Without a horizontal offset, i.e., in today's practice, the print path portions of the individual print path layers lie directly on top of one another. In this case, a virtual line applied to the connection contour has an inclination angle of 0 degrees, i.e., the print path ends are flush or, in the case of non-end print path portions, the lateral surface of the first printed component portion is also perpendicular to the work surface in the connection region.

In the present invention, however, space for the material dispensing unit is created in the form of the collision space by providing a horizontal offset of the print path portions. This can take the shape of an oblique lateral surface (side surface of the printed print path layers of the first component portion) and/or an obliquely stepped end edge of the printed print path layers of the first component portion in the region of the print path portions.

In the region of the connection region, the second component portion to be printed can form the negative of the first printed component portion.

Thus, the second printed component portion can have at least two print path layers, layered on top of one another, in the at least one connection region, wherein at least one upper print path portion and at least one lower print path portion of the at least two print path layers, layered on top of one another, of the second component portion are layered on top of one another with a horizontal offset in such a way that, when viewed in a cross-section of the at least one connection region, they have a second connection contour that is substantially opposite to the first connection contour.

Accordingly, when planning the connection region, a virtual connection line, which is applied to the second connection contour when viewed in a cross-section of the at least one connection region, can enclose a second inclination angle with a normal to the work surface that corresponds to the first inclination angle of the first connection contour. Of course, for the purpose of avoiding a collision of the material dispensing unit with the printed print path layers of the first component portion, it is also conceivable that the second inclination angle is less than the first inclination angle. During the manufacturing process, this may then result in a gap that increases layer by layer between the first component portion and the second component portion.

In principle, in a simple embodiment of the invention, it is conceivable, when planning the connection region, to choose a first inclination angle that has a fixed standard value from the mentioned maximum value range of 0 to 90 degrees, in particular of 5 to 80 degrees. Such a fixed standard value can, for example, result from an analysis of the commonly used material dispensing units and their collision behaviors.

However, the method according to the invention can furthermore comprise a further step, which is in particular advantageous in connection with systems in which the material dispensing unit can be replaced or adjusted.

The method may furthermore comprise an analysis of the outer geometry of the material dispensing unit, the results of which can be used as a basis for the planning of the connection region.

It may be provided that, in such an analysis, on the basis of a proximal end of the material output, a printing normal to the work surface that passes through a dispensing opening at the proximal end of the material dispensing unit is determined first.

Furthermore, a virtual printing line of the material dispensing unit can be determined.

The proximal end of the material dispensing unit refers to the free end of the material output, which faces the work surface during the printing process. Accordingly, the dispensing opening for dispensing the building material is provided at the proximal end of the material dispensing unit.

The so-called printing normal is a perpendicular line to the work surface that extends through the dispensing opening. It coincides with the longitudinal axis of the material dispensing unit if the material dispensing unit is not tilted.

In addition to the printing normal, the virtual printing line of the material dispensing unit, which is specific to the material dispensing unit, is also determined in the present case. It depends significantly on the specific outer geometry of the material dispensing unit used. At the beginning, it has already been explained which components, by way of example, can influence the shape and outer geometry of the material dispensing unit. These components are not adjusted according to the invention but can be taken into account in the determination of the horizontal offset through the development of the method according to the invention.

The virtual printing line of the material dispensing unit is applied to the outer geometry of the material dispensing unit, starting from a virtual center of rotation on a radial outer edge of the proximal end of the material dispensing unit.

On the basis of the virtual printing line and the printing normal, a virtual printing angle that is enclosed by the printing normal to the work surface and the virtual printing line can be ascertained.

In order to apply the virtual printing line to the outer geometry of the material dispensing unit, a virtual line through an assigned virtual center of rotation is rotated starting from a horizontal starting position about the virtual center of rotation in the direction toward the outer geometry of the material dispensing unit until the virtual line comes to rest on a radial outer point of the material dispensing unit. In this position, it forms the virtual printing line for the assigned center of rotation.

In a particularly simple embodiment, the later orientation of the material dispensing unit during the actual printing of the second (further) component portion in relation to the already printed print path layers and thus the actual horizontal space requirement of the specific material dispensing unit can be disregarded. Instead, only the maximum space requirement of the specific material dispensing unit can be considered.

Furthermore, it is also conceivable to disregard the actual vertical space requirement of the material dispensing unit, i.e., to also include components that are arranged above the maximum height of the already printed component portion during printing.

Generally, however, the orientation of the material dispensing unit is also already calculated when calculating the print paths in preparation for the additive manufacturing, although this orientation does not always have to remain the same. In particular, when calculating the print paths in preparation for the additive manufacturing, it can be taken into account that, if possible, the radially projecting components of the material dispensing unit should not point in the direction of already existing component structures when printing in the vicinity of these existing component structures.

Accordingly, in an alternative design of the development of the method, the actual orientation of the material dispensing unit can be taken into account in the determination of the radial outer point for the virtual printing line. Accordingly, the virtual center of rotation may comprise a point on a radial outer edge of the proximal end of the material dispensing unit that is closest to the connection region when printing the at least one print path layer of the second component portion.

In an alternative or additional development of the invention, the analysis of the outer geometry of the material dispensing unit can be limited to a (vertical) geometric region of the outer geometry of the material dispensing unit that can enter the collision space of the first component portion when printing the at least one print path layer of the second component portion.

Accordingly, both the vertical distance of the proximal end of the material dispensing unit to the work surface for the print path layers to be printed of the further component portion and the horizontal collision plane of the first or previously printed component portion, i.e., the maximum height of the first component portion, can be taken into account. Taken into account in the analysis are accordingly only the parts of the outer geometry of the material dispensing unit that are located below the horizontal collision plane of the first or previously printed component portion when printing the at least one print path layer of the second (or further) component portion.

The material dispensing unit may comprise a housing that defines the outer geometry.

The housing can be designed in one part or multiple parts, wherein different parts can in particular be assigned to different functional elements. For example, a housing part of the material dispensing unit (nozzle) can bear the geometry for receiving and dispensing the building material (nozzle). This housing part can be designed to be detachable, replaceable and movable, in particular rotatable, relative to the rest of the housing. A housing part can be designed to receive the building material (hopper). A further housing part (e-box) can be designed to accommodate, for example, electronic, electromechanical, sensor and/or motor elements.

In the region of the proximal end, the housing is generally designed with an end face in which the dispensing opening is formed. The horizontal end surface thus defines the proximal end and comprises a circumferential radial outer edge.

Regardless of whether and how such a housing can be designed, in one embodiment of the invention, the analysis of the outer geometry of the material dispensing unit can comprise the calculation of a virtual outer shell, in particular in the shape of a cone or truncated cone, a pyramid or truncated pyramid, which encloses the material dispensing unit, wherein the proximal end of the material dispensing unit comprises the tip or top surface of the virtual outer shell.

Such a geometrically simplified outer shell makes it possible to ascertain the specific space requirement of the material dispensing unit depending on its orientation with respect to the already printed component portion(s) and the connection region(s) with less computational effort, analogously to the determination of a virtual printing line. On the basis of this analysis, the print path portions and the respective horizontal offset can then be provided, and the at least one connection region can be planned.

The outer shell can, for example, be calculated on the basis of the largest ascertained (or manually entered) printing angle.

The analysis of the outer geometry of the material dispensing unit can also comprise the determination of a plurality of virtual printing lines. In this case, individual points of the radial outer edge of the proximal end can each comprise a virtual center of rotation for the determination of an assigned virtual printing line, in such a way that the virtual outer shape has a plurality of virtual printing lines.

For example, several printing lines in several orientations, for example four virtual printing lines when the material dispensing unit is in each case rotated by 90 degrees about the printing normal, can be ascertained on the basis of assigned virtual centers of rotation. The selected orientations can correspond to the most common orientations of the material dispensing unit in the direction toward the connection region. Of course, more or fewer orientations than the four orientations mentioned by way of example are also conceivable.

In the case of irregular shapes, such as a pyramid or a truncated pyramid, with a polygonal base, the side surfaces that form the lateral surface can have different inclinations. The same applies, for example, to a virtual outer shell that comprises an oblique cone or oblique truncated cone.

In a development of the invention, the analysis of the outer geometry of the material dispensing unit can comprise the determination of a plurality of virtual printing lines, wherein each point of the radial outer edge of the proximal end can comprise a virtual center of rotation for the determination of assigned virtual printing lines, in such a way that the virtual outer shape has a plurality of virtual printing lines.

In this solution, a rotation about the printing normal by 360 degrees, i.e., a complete rotation, is carried out, and an assigned virtual printing line is created as a virtual center of rotation for each point of the radial outer edge. In this way, a specific outer shell can be created over the entire circumference of the material dispensing unit.

If the vertical distance of the proximal end of the material dispensing unit to the work surface for the print path layers to be printed of the further component portion and the horizontal collision plane of the first component portion are also taken into account, this allows optimal planning of the connection region.

In a development of the invention, the analysis of the outer geometry of the material dispensing unit can be carried out on the basis of sensor data or sensor signals and/or on the basis of data or signals assigned to the material dispensing unit and/or on the basis of data or signals manually entered by a user.

For example, existing sensor units that are already used for the additive manufacturing can provide sensor data that are characteristic of the specific material dispensing unit and/or that can be used to ascertain the virtual printing line.

In the first case, an assignment of the specific material dispensing unit can take place, wherein a database with, for example, stored data on specific material dispensing units can be used as part of the analysis. For example, different virtual outer shells and/or virtual printing lines can be stored for different material dispensing units.

Alternatively or additionally, the specific material dispensing unit can also be correspondingly assigned via data or signals sent by the material dispensing unit. For example, data sent from the material dispensing unit to a control unit can also contain information that make it possible to correspondingly assign the specific material dispensing unit. On the basis thereof, the control unit can access an internal or external database comprising data stored on the specific material dispensing units.

In the same way, a corresponding assignment of the specific material dispensing unit can alternatively or additionally also take place on the basis of data or signals entered manually by a user. For example, the user can enter the specific type of the material dispensing unit and, for example, the control unit, taking this type into account, accesses type-specific data on specific material dispensing units in an external or internal database. In a particularly simple solution, the user can also manually enter a virtual printing line or the virtual printing angle as part of the analysis.

As already indicated, sensor data can however also be used to ascertain the virtual printing line. For example, position sensors and/or optical recording devices and/or line lasers or other optical sensors used for the real-time control of the manufacturing process can also provide information about the relevant outer dimensions of the material dispensing unit, which can be used to calculate the virtual printing line, the printing normal, and/or the virtual printing angle.

According to a development of the method according to the invention, in the step of printing the first component portion, the horizontal offset and thus the first inclination angle of the virtual collision line can be selected to be at least so large that, when a proximal end of the material dispensing unit is located at the vertex of the inclination angle, the virtual printing angle facing the first component portion is less than or equal to the first inclination angle.

The present invention also relates to a device with the features of claim 19, which is designed to carry out the method described above.

The above statements concerning the method according to the invention likewise apply here.

Furthermore, in addition to the already discussed material dispensing unit, actuator assembly for moving the material dispensing unit, and control unit for controlling the actuator assembly, a planning unit for planning at least one connection region of the at least two component portions adjacent to one another can also be provided. As already explained above in connection with the method, the planning can take place manually, semi-automatically or automatically, by means of or with the aid of the control unit and/or further components.

The planning unit can be designed as an integral part of the control unit or as a separate unit that is in communicative connection with the control unit.

According to a development of the invention, the planning unit can be configured to analyze an outer geometry of the material dispensing unit on the basis of data or signals provided by at least one sensor and/or by the material dispensing unit and/or a database and/or through manual input by a user.

Consequently, the planning unit can also be in communicative connection with a sensor unit of the device and/or with an input unit for manual input. Furthermore, an optional database for providing specific information on the material dispensing unit can be an integral part of the planning unit, of the control unit or can be a separate unit in communicative connection with the planning unit and/or the control unit.

The communicative connection can be wired, cabled or wireless via the common wireless connection paths, for example via radio, WLAN or Bluetooth.

The sensor unit can, for example, comprise at least one of the following sensors: mechanical sensor, optical sensor, optical recording device, capacitive sensor, inductive sensor.

Furthermore, the present invention also relates to the use of a device according to the invention or the application of the method according to the invention for the additive manufacturing of a component which has several component portions, in particular of a building or of parts of buildings, and to an additively manufactured three-dimensional component which is produced according to the method according to the invention or with a device according to the invention, wherein the component has at least two neighboring component portions which are additively manufactured adjacently to one another in a horizontal plane.

Finally, the invention also relates to a computer program comprising control commands which, when the program is executed by a control unit, cause the latter to execute a method according to the above and below statements.

The control unit can be designed as a microprocessor. Instead of a microprocessor, any further device for implementing the control unit can also be provided, for example one or more arrangements of discrete electrical components on a printed circuit board, a programmable logic controller (PLC), an application-specific integrated circuit (ASIC) or another programmable circuit, for example also a field programmable gate array (FPGA), a programmable logic array (PLA), and/or a commercially available computer.

The statements relating to the control unit also apply to the planning unit, whether as an integral part of the control unit or as a separate unit which is in communicative connection with the control unit.

Features that have been described in connection with one of the subjects of the invention, namely, given by the method according to the invention, the device according to the invention, the use according to the invention, the component according to the invention, or the computer program according to the invention, can also be advantageously implemented for the other subjects of the invention. Likewise, advantages that were mentioned in connection with one of the subjects of the invention can also be understood in relation to the other subjects of the invention.

In addition, it should be pointed out that terms such as “comprising,” “having,” or “with” do not exclude any other features or steps. Furthermore, terms such as “one” or “the” which refer to a single number of steps or features do not exclude a plurality of features or steps-and vice versa.

In a puristic embodiment of the invention, however, it may also be provided that the features introduced in the invention by the terms “comprising”, “having” or “with” are exhaustively enumerated. Accordingly, one or more enumerations of features may be considered complete within the scope of the invention, for example, each considered for each claim. The invention can consist, for example, exclusively of the features mentioned in claim 1.

It should be noted that designations such as “first” or “second”, etc., are used primarily for purposes of distinguishing respective device or process features and are not necessarily intended to imply that features are mutually dependent or interrelated.

Furthermore, it should be emphasized that the values and parameters described herein include deviations or fluctuations of ±10% or less, preferably ±5% or less, more preferably ±1% or less, and very particularly preferably ±0.1% or less of the named value or parameter, provided that these deviations are not ruled out in practice in the implementation of the invention. The indication of ranges by initial and end values also comprises all those values and fractions which are enclosed by the designated range, in particular the initial and end values and a respective average value.

Exemplary embodiments of the invention are described in more detail below with reference to the drawings.

The figures each show preferred embodiments in which individual features of the present invention are shown in combination with one another. Features of an embodiment can also be implemented separately from the other features of the same embodiment and can accordingly be easily combined with features of other embodiments by a person skilled in the art to form further useful combinations and subcombinations.

In the figures, functionally identical elements are provided with the same reference signs.

### BRIEF DESCRIPTION OF THE DRAWINGS

In the figures, schematically:

FIG. 1 shows a simplified structure of a 3D printer in gantry design;

FIGS. 2a, 2b show a top view and a side view of a simplified representation of a multi-part component, which is printed with the device according to the invention or using the method according to the invention;

FIG. 3 shows the device according to the invention of FIG. 2b in a more detailed representation;

FIG. 4 shows a plan view of a simplified representation of an alternative multi-part component, which is to be printed with the device according to the invention or using the method according to the invention;

FIG. 5 shows a side view of the multi-part component of FIG. 4; and

FIG. 6 shows an explanatory view of the analysis of the material dispensing unit according to the representation of FIG. 3.

### DETAILED DESCRIPTION

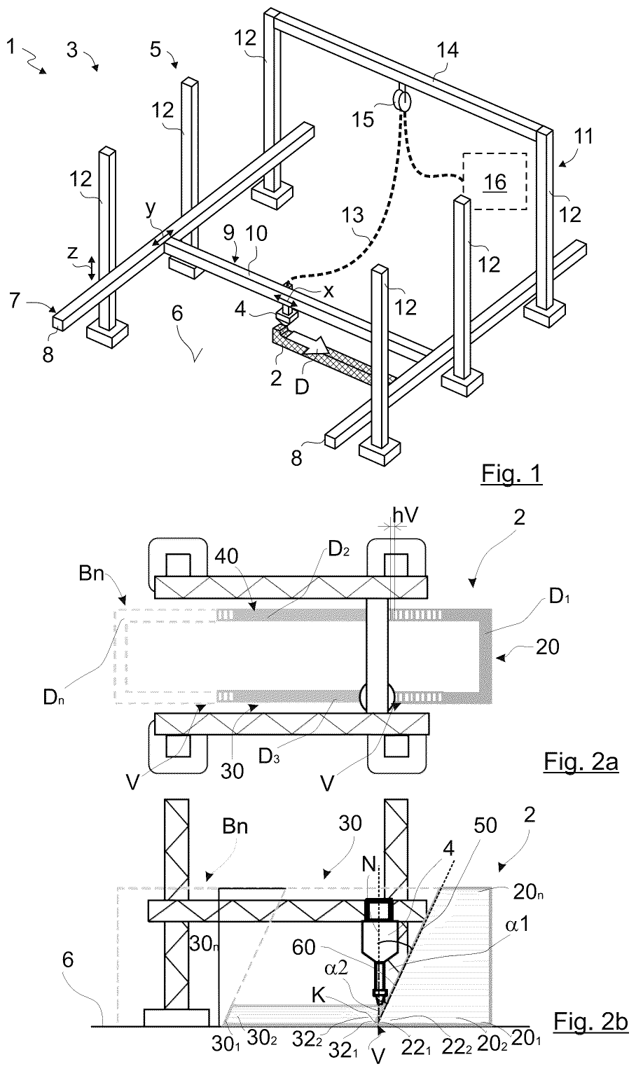

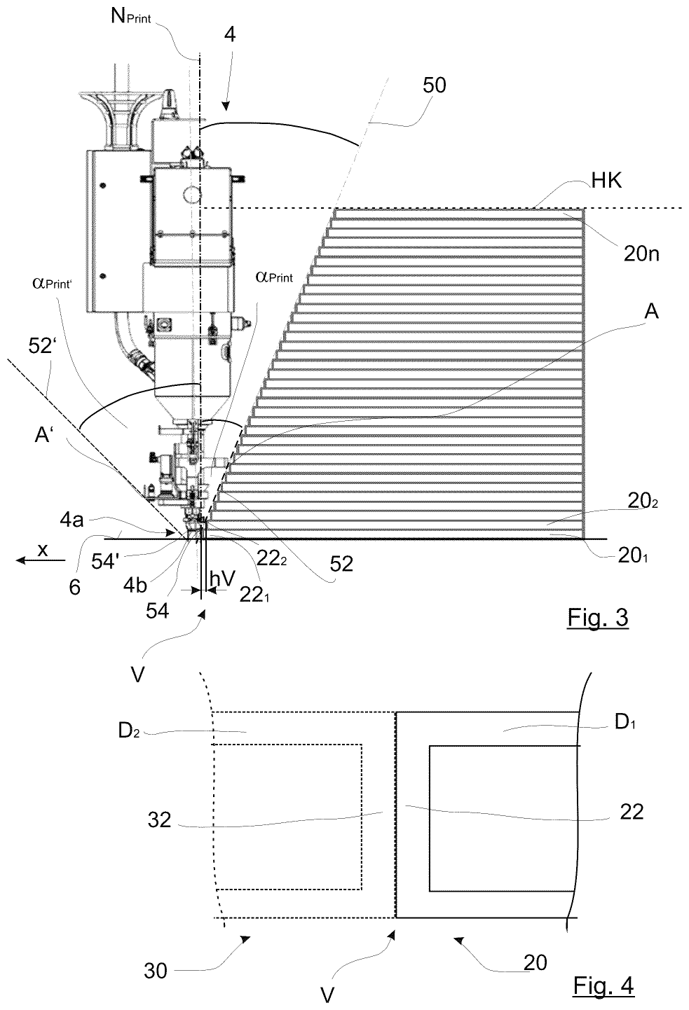

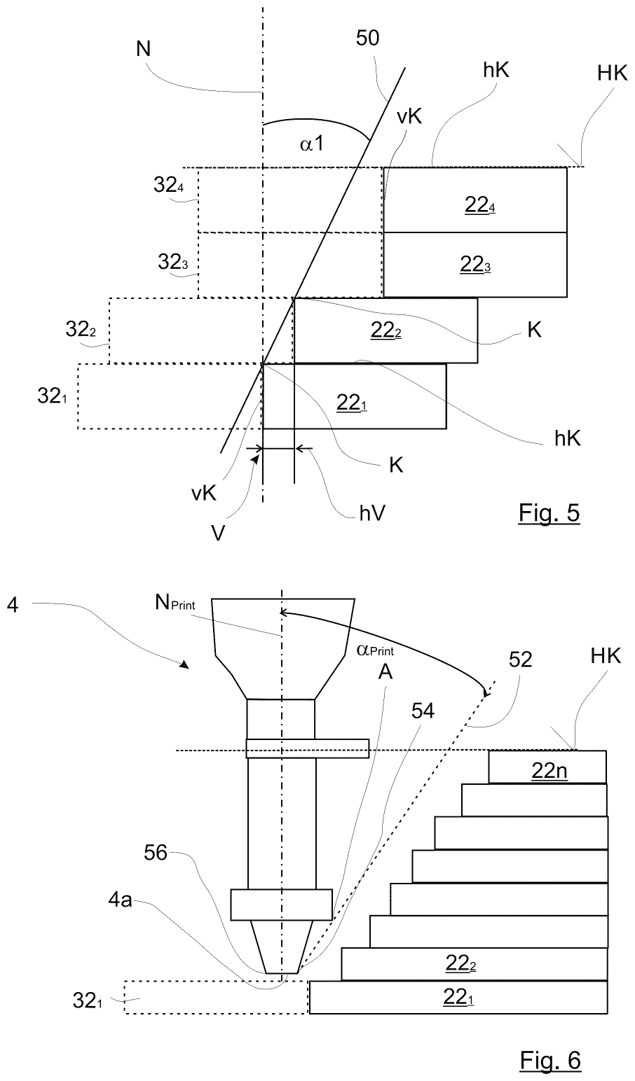

FIG. 1 shows a highly simplified arrangement 1 for the additive manufacturing of a component 2. FIGS. 2a and 2b show and explain the definition of a horizontal offset when planning the connection regions of a multi-part component; FIGS. 3 and 6 show and explain the analysis of the material dispensing unit as a possible basis for planning the connection regions. In FIGS. 2a, 2b, 3 and 6, the component portions are adjacent to one another in the region of their print path ends, i.e., the connection regions V extend along the width of the print path portions that are adjacent to one another. The additional FIGS. 4 and 5 are intended to show alternatively how the component portions can also be adjacent to one another with parallel print path portions and how the connection region V can be designed in this case. Component portions that have not yet been printed or (“second”) component portions or print path portions thereof that are to be printed subsequently may be shown as dashed lines or in grayscale.

The arrangement 1 according to FIG. 1 comprises a device 3 for additively manufacturing the component 2, with a material dispensing unit 4, indicated only schematically, for depositing a building material, and an actuator assembly 5, which is designed to move the material dispensing unit 4 over a work surface 6 in order to deposit the building material layer by layer in predetermined print paths D.

The invention is described below in particular in the context of 3D concrete printing, i.e. for the additive manufacture of a component 2 of a structure or of a complete structure from flowable mixed concrete. However, this is fundamentally not to be understood as limiting. The invention is basically suitable for producing any additive components from any building material, in particular also for the manufacture of plastic components.

In order to move the material dispensing unit 4, the actuator assembly 5 has at least one first horizontal guide 7, which in FIG. 1 and the following exemplary embodiments are each two horizontal supports 8 arranged in parallel and at a distance from one another. A second horizontal guide 9 is provided between these two horizontal supports 8, which guide is thus linearly movable along the first horizontal guide 7. The second horizontal guide 9 is designed as an individual cross-member 10 along which the material dispensing unit 4 can be moved in the manner of a trolley, i.e. transversely to the first horizontal guide 7. Finally, a two-dimensional movement of the material dispensing unit 4 over the work surface 6 can be allowed by the two horizontal guides 7, 9 (cf. arrows “x” and “y”).

In addition, the actuator assembly 5 according to FIG. 1 has a vertical guide 11 along which the material dispensing unit 4 can be moved vertically relative to the work surface 6. Specifically, it can be provided that the vertical guide 11 has two groups of vertical struts 12, wherein the vertical struts 12 of each group are spaced apart from one another and are arranged in alignment with one another, and wherein both groups are spaced apart from one another. The first horizontal guide 7, or the horizontal supports 8 of the first horizontal guide 7, can thus be moved along the vertical struts 12 of the corresponding group (cf. arrow “z”).

A traverse 14, which is mounted, for example, on two vertical struts 12 of the vertical guide, also carries a deflection roller 15 via which a conveying hose 13 for dry mortar is guided from a material preparation unit 16 (indicated as a black box) to the material dispensing unit 4.

FIG. 1 and the exemplary embodiments thus show a 3D concrete printer in gantry design with linear axis guidance in each case. This allows the material dispensing unit 4 to move along all translational degrees of freedom x, y, z. Gantry printers, in particular for manufacturing concrete components 2 from concrete, are already known in principle, which is why additional details are not discussed further here.

The objective of the present invention is to improve the print quality of the print path layers 20, layered on top of one another, by an optimal length of the individual print paths D₁, D₂, D₃ to Dn (cf. FIGS. 2a and 2b).

This objective is achieved by composing the component 2 from several component portions 20, 30, 40 and Bn. In order to be able to dispense the component portions 20, 30, 40, Bn adjacently to one another in their connection regions V, a method and a device are proposed according to the invention in which the specific space requirement of the material dispensing unit 4 is taken into account in the planning of the connection region V.

FIGS. 2a and 2b show a plan view (FIG. 2a) and a side view (FIG. 2b) of the connection regions of several component portions, which connection regions are planned according to the method according to the invention and formed by means of the device according to the invention.

A component 2 is divided into several component portions 20, 30, 40, Bn, which can be printed one after the other (first component portion 20) and/or in partial portions (component portions 30 and 40) in the representation shown.

The component portions of the finished component 2 are adjacent to one another in the connection regions V. For this purpose, each of the print path layers 20₁, 20₂, 20ₙ of the first component portion has a print path portion 22₁, 22₂, 22ₙ which, in the representation shown, is adjacent to a corresponding print path portion 32₁, 32₂, 32ₙ of the print path layers 30₁, 30₂, 30ₙ.

The print path portions in the embodiment of FIGS. 2a, 2b are formed in the region of the print path ends.

Instead, they can, however, also be formed in another region of the print path, for example, as shown in a simplified manner in FIGS. 4 and 5, in a central region of the print path D₁ or D₂ (cf. the print path portions 22, 32 in FIG. 4). In this case, the neighboring print path portions 22 of the first component 20 and the print path portions 32 of the second component 30 are parallel to one another along the connection region V. The horizontal offset (in FIG. 5) leads to a lateral offset of the print path portions layered on top of one another, for example to the right in the representation of FIG. 5.

It can be seen in FIGS. 3 and 5 as well as in FIG. 2b that the connection regions V are not formed by two vertical print path ends, as known in the prior art.

Instead, the print path portions 22₁, 22₂, 22ₙ of the first component portion 20 are layered with a horizontal offset hV relative to one another. In this case, subsequent print path layers are offset with respect to the respectively underlying print path layers by the horizontal offset hV in the direction away from the connection region V (and the adjacent component portions 30 and 40 to be printed) so that space is created for the material dispensing unit 4 (cf. FIG. 2b and FIG. 6).

This can take place in the same way with a design according to FIGS. 4 and 5.

In the embodiments shown, a horizontal offset hV of the print path portions relative to one another is in each case provided from layer to layer so that this results in a regular gradation of the connection contour when viewed in cross-section (cf. FIG. 3).

Alternatively, however, irregular horizontal offsets with deviations in height (e.g., due to different numbers of layers between the offset pieces) and in depth (e.g., due to differently sized horizontal offsets) are also conceivable. The gradations can also take place regularly, but not layer by layer, but, for example, only every two print path layers, every three print path layers, or the like. In this regard, reference is also made to FIG. 5.

In the representation shown, the material dispensing unit 4 comprises several components, which are not described in more detail here, such as a hopper, nozzle, dispensing opening, and e-box. The decisive factor is that, at its proximal end 4a in relation to the work surface 6, the building material is dispensed.

In a simple embodiment, the method according to the invention can plan the connection region V between two component portions 20, 30.

In particular, the further planned parameters of the additive manufacturing process can also be taken into account, such as the number of the print path layers of the first component portion to be printed, the maximum height of the first component portion to be printed, the planned height of the individual print path layers of the first component portion to be printed (cf. also the horizontal collision plane HK of the first component portion 20), and the like.

In this way, a virtual collision line 50 can be applied to a planned connection contour in order to adjust the latter accordingly as part of the planning.

In the representation shown in FIGS. 2b and 5, the collision line 50, which is applied to the connection contour of the first component portion 20 when viewed in a cross-section of the connection region V, encloses a first inclination angle α1 with a normal N to the work surface. As shown, this can be in an angular range of in particular 5 to 80 degrees.

In particular, if, as shown here, more than one horizontal offset and thus more than one step are provided in the connection contour, the result is that a virtual curve applied to the connection contour comprises a line if the steps are formed regularly in height and depth. This means that the horizontal offset is of the same size and the number of print path layers between the rearward offset print path portions is always the same, for example a horizontally offset print path portion is applied onto the print path portion of the lower print path layer in each print path layer, as shown in FIG. 3.

However, even if the gradation is not to be regular, i.e., if the step height and/or step depth vary, a virtual collision line can be ascertained, as shown in FIG. 5.

In this case, the virtual collision line 50 can in particular be selected such that no portion of the first component portion 20 protrudes into a so-called collision region, i.e., that a corresponding collision space remains free when printing the print path layers of the first component portion 20.

In a cross-sectional view of the connection region V, the collision region is limited by the virtual collision line 50, the normal N to the work surface, and a horizontal collision plane HK of the first component portion 20.

The horizontal collision plane HK specifies the maximum height of the planned first component portion 20 and coincides with a horizontal collision plane hK of the uppermost print path layer 22₄ in FIG. 5.

The virtual collision line 50 intersects the normal N to the work surface 6 and thus defines the vertex for the first inclination angle α1. In order to be able to dispense the print path portions of the neighboring component portions 20, 30 adjacently to one another with as little gap as possible or with a minimal gap (for example, of at most 50 mm, advantageously at most 30 mm, preferably at most 20 mm), the vertex of the first inclination angle α1 is placed on a collision edge K (cf. FIG. 2b) of the lowest print path layer, or the first print path layer to be printed, of the first component portion 20.

As part of the planning, a print path layer can have a rectangular or almost rectangular cross-section, as shown in the representation in FIGS. 2b, 3, 5, and 6. When viewed in the cross-section of the connection region, the collision edge K of a print path layer refers to the (exposed) edge, facing the component portion to be printed, (shown in the view of FIGS. 2b and 5 as the upper corner point of the lowest step) of the upper side of the assigned print path layer of the first component portion 20.

The collision edge K of a print path layer is generally obtained by an intersection line of a horizontal collision plane hK of the respective print path layer and a vertical collision plane vK of the respective assigned print path layer (cf. FIG. 5).

By planning a virtual collision line 50, together with the normal N to the work surface and a horizontal collision plane HK lying on an upper surface of the uppermost print path layer of the planned first component portion 20, the collision region and, accordingly, the collision space are defined, which the material dispensing unit 4 can enter during the later manufacturing process in order to print the second component portion without colliding with the first, already printed component portion.

The first inclination angle α1 can be a fixed standard value that is suitable for most, if not all, typically used material dispensing units, for example greater than 60 degrees. In this way, a standardized collision region can be defined.

In a development of the method according to the invention and the device according to the invention, an additional analysis of the outer geometry of the actually used material dispensing unit can however take place in order to adapt the first inclination angle α1 to the actual space requirements of the material dispensing unit used. In this respect, reference is also made to FIGS. 3 and 6.

Thus, during the analysis, a printing normal N_{Print} can be ascertained first, which, like the normal N, is perpendicular to the work surface 6.

Furthermore, a virtual printing angle α_{Print} is ascertained. This printing angle is between the printing normal N_{Print} and a virtual printing line 52, which is applied to an outer point A of the outer geometry of the material dispensing unit 4 and extends through a virtual center of rotation 54.

This printing angle α_{Print} can accordingly be used instead of a standard value for the determination of the first inclination angle α1, whereby the connection regions V of the component portions can be specifically adapted to the material dispensing unit 4 used.

It can be seen in FIG. 3 that a virtual printing line 52′, which is applied to the side of the outer geometry of the material dispensing unit 4 oriented in the direction x (printing direction for the second component portion), spans a different (larger) virtual printing angle α_{Print} to the printing normal N_{Print} than the virtual printing line 52, which is applied in the direction toward the first component 20 to the outer geometry of the material dispensing unit 4.

In order to apply the virtual printing line 52, 52′ to the outer geometry of the material dispensing unit 4 that is relevant to the later manufacturing process, the height of the material dispensing unit 4 in the additive manufacturing process and the maximum height of the component portion(s) already printed according to the planning (referred to as HK in FIGS. 3 and 6) are ascertained first. Taken into account in this case is only the outer geometry of the material dispensing unit 4 which, in its working position, is located below the horizontal collision plane HK of the component portion(s) already printed according to the planning (in the case of several component portions already printed, the horizontal collision plane HK with the greatest distance from the work surface 6 is relevant).

Furthermore, as part of the analysis, a virtual line is placed through an assigned virtual center of rotation 54 on the radial outer edge 56 of the proximal end 4a of the material dispensing unit 4 and, starting from a horizontal starting position, is rotated about the virtual center of rotation 54 in the direction toward the (relevant) outer geometry of the material dispensing unit 4 until this virtual line comes to rest on a radial outer point A, A′ of the (relevant) outer geometry of the material dispensing unit 4. In this position, it forms the virtual printing line 52 for the assigned center of rotation 54.

The virtual center of rotation 54, 54′ is a point on the radial outer edge 56 of the proximal end 4a of the material dispensing unit 4. In this case, the virtual center of rotation 54 can in particular be selected such that it faces the already printed component portion 20 when printing the print path layers of the further component 30 (cf. FIGS. 3 and 6).

In a simpler design variant of the method according to the invention and of the associated device according to the invention, the largest virtual printing angle α_{Print}′ of the material dispensing unit 4 can be used as a basis for the planning of the connection region(s) V. Accordingly, a virtual outer shell can be calculated, which, for the entire circumference of the proximal end, inscribes the material dispensing unit 4 with the largest virtual printing angle α_{Print}′ thereof. For this purpose, the ascertained printing line 52′ with the largest virtual printing angle is rotated by 360 degrees about the central longitudinal axis of the material dispensing unit 4, resulting in the lateral surface of a truncated cone.

Alternatively, however, it is also possible that the orientation of the material dispensing unit 4 toward the connection region V or toward the already printed component portion 20 is already taken into account in the analysis, and the relevant virtual printing angle α_{Print}, i.e., the one facing the adjacent component portion, is accordingly used as a basis. In this case, the outer shell for these specific orientation(s) can theoretically be calculated on the basis of one or more printing angle(s) α_{Print} facing the adjacent component portion, and the associated printing lines, wherein the outer shell can, for example, have the shape of a truncated pyramid with a polygonal base in the case of several different orientations.

In the planning, regardless of whether a specific virtual printing angle α_{Print} or a non-specific maximum virtual printing angle α_{Print}′ from the analysis is included, the first inclination angle α1, instead of being fixed to a fixed standard value, can be selected in such a way that it is greater than or equal to the virtual printing angle α_{Print} or α_{Print}′.

In particular, in one embodiment of the invention, each point of the outer edge of the proximal end 4a of the material dispensing unit 4 can form a virtual center of rotation 54 for an assigned virtual printing line 52, and the lateral surface of an outer shell calculated based thereon can be spanned by the plurality of virtual printing lines.

Finally, it can also be seen in FIG. 2b that the second component 30, in the region of its adjacent print path portions 32, has a connection contour that is substantially negative to the connection contour of the first component 20. Accordingly, here too, the print path portions 32 of the individual print path layers are layered on top of one another with a horizontal offset hV, but in an overhang, as shown in FIG. 2b. The “gap” created for the space requirement of the material dispensing unit 4 by the horizontal offset hV to the rear, i.e., the collision space, is closed or minimized in this way so that the print path portions of the neighboring component portions 20, 30 can be adjacent to one another.

Accordingly, in the embodiment shown, a second inclination angle α2 is equal to or slightly less than the first inclination angle α1, regardless of how the first inclination angle α1 was ascertained.

Not shown are the optional sensor unit and/or input unit of the device, which can be used for a simplified analysis of the outer geometry of the material dispensing unit 4. On this, see the statements in the introduction to the description.

1. A method for additively manufacturing a component, wherein the manufactured component has at least two component portions neighboring in a horizontal plane, which are adjacent to one another in at least one connection region; comprising the steps of:
planning the at least one connection region (V) of the component portions adjacent to one another;
controlling a material dispensing unit (4) for depositing a building material; and
controlling an actuator assembly (5) which is designed to move the material dispensing unit (4) over a work surface (6) in order to deposit the building material layer by layer in predetermined print paths,
wherein first at least two print path layers, layered on top of one another, of a first of the at least two component portions adjacent to one another and then at least one print path layer of a second of the at least two component portions adjacent to one another are deposited;
wherein the connection region is planned in such a way that the at least one print path layer of the second component portion in the at least one connection region has a print path portion which can be deposited by the material dispensing unit adjacently to a print path portion of a corresponding print path layer of the first component portion so that the corresponding print path layers of the at least two component portions can be adjacent to one another in the at least one connection region, and
wherein, according to the planning of the at least one connection region, at least one upper print path portion and at least one lower print path portion of the at least two print path layers, layered on top of one another, of the first component portion are layered on top of one another with a horizontal offset in such a way that a collision of the material dispensing unit with the printed print path layers of the first component portion is avoided when printing the at least one print path layer of the second component portion.

2. The method according to claim 1,
wherein the at least one upper print path portion and the at least one lower print path portion of the at least two print path layers, layered on top of one another, to one another, define a first connection contour that deviates from a normal to the work surface, when viewed in a cross-section of the at least one connection region.

3. The method according to claim 2,
wherein the step of planning the connection region comprises the planning of a virtual collision line which, when viewed in a cross-section of the at least one connection region, encloses a first inclination angle with a normal to the work surface that is greater than 0 degrees and less than 90 degrees, wherein the vertex of the first inclination angle is placed on a collision edge of the lowest print path layer, or the first print path layer to be printed, of the first component portion.

4. The method according to claim 3,
wherein, when viewed in a cross-section of the at least one connection region, the virtual collision line, the normal to the work surface, and a horizontal collision plane of the print path layers of the first component portion define a free collision region into which no portion of the print path layers of the first component portion protrudes, and wherein the horizontal collision plane of the first component portion comprises a horizontal plane lying on an upper surface of the uppermost print path layer of the first component portion.

5. The method according to claim 3,
wherein the collision edge of a print path layer comprises an actually provided or virtual edge of a print path layer which is defined by an intersection line of a horizontal collision plane, which lies horizontally on the upper side of the print path layer, and a vertical collision plane, which lies vertically on the side of the print path layer that faces the adjacent print path portion to be printed of the further component portion.

6. The method according to claim 3,
wherein the first inclination angle is greater than 5 degrees and less than 80 degrees.

7. The method according to claim 2,
wherein the second printed component portion has at least two print path layers, layered on top of one another, at least in the connection region, wherein at least one upper print path portion and at least one lower print path portion of the at least two print path layers, layered on top of one another, of the second component portion are layered on top of one another with a horizontal offset in such a way that, when viewed in a cross-section of the at least one connection region, they have a second connection contour which is substantially opposite to the first connection contour,
wherein the step of planning the connection region comprises the planning of a virtual connection line which, when viewed in a cross-section of the at least one connection region, is applied to the second connection contour, encloses a second inclination angle with a normal to the work surface that corresponds to or is less than the first inclination angle of the first connection contour.

8. (canceled)

9. The method according to claim 1,
wherein the method furthermore comprises an analysis of the outer geometry of the material dispensing unit, in which, on the basis of a proximal end of the material dispensing unit,
a printing normal to the work surface is determined that passes through a dispensing opening at the proximal end of the material dispensing unit,
a virtual printing line of the material dispensing unit is determined, which is applied to the outer geometry of the material dispensing unit, starting from a virtual center of rotation on a radial outer edge of the proximal end of the material dispensing unit,
at least one virtual printing angle is ascertained, which is enclosed by the printing normal to the work surface and the virtual printing line.

10. The method according to claim 9,
wherein, in the step of applying the virtual printing line to the outer geometry of the material dispensing unit, a virtual line, which runs through an assigned virtual center of rotation, on the radial outer edge of the proximal end of the material dispensing unit is rotated, starting from a horizontal starting position, about the assigned virtual center of rotation in the direction toward the outer geometry of the material dispensing unit until the virtual line comes to rest on a radial outer point of the material dispensing unit in order to form the corresponding virtual printing line,
wherein the analysis of the outer geometry of the material dispensing unit is limited to a geometric region of the outer geometry of the material dispensing unit which can enter the collision region according to claim 4 when printing the at least one print path layer of the second component portion.

11. The method according to claim 9,
wherein the virtual center of rotation comprises a point on a radial outer edge of the proximal end of the material dispensing unit which is closest to the connection region when printing the at least one print path layer of the second component portion.

12. The method according to claim 9,
wherein the analysis of the outer geometry of the material dispensing unit comprises the calculation of a virtual outer shell, in particular in the shape of a cone or truncated cone, a pyramid or truncated pyramid, which encloses the material dispensing unit, wherein the proximal end of the material dispensing unit comprises the tip or top surface of the virtual outer shell.

13. The method according to claim 9,
wherein the analysis of the outer geometry of the material dispensing unit comprises the determination of a plurality of virtual printing lines, and each point of the radial outer edge of the proximal end comprises a virtual center of rotation for the determination of assigned virtual printing lines, in such a way that the virtual outer shape has a plurality of virtual printing lines.

14. The method according to claim 9,
wherein the analysis of the outer geometry of the material dispensing unit is carried out on the basis of sensor data or sensor signals and/or on the basis of data or signals assigned to the material dispensing unit and/or on the basis of data or signals manually entered by a user.

15. The method according to claim 3,
wherein, in the step of planning the connection region, the horizontal offset and, if applicable, the first inclination angle of the virtual collision line is selected to be at least so large that, when a proximal end of the material dispensing unit is located at the vertex of the inclination angle, the virtual printing angle facing the already printed first component portion is less than or equal to the inclination angle is.

16. A device for the additive manufacturing of a component, wherein the manufactured component has at least two component portions neighboring in a horizontal plane, comprising:
a material dispensing unit for depositing a building material;
an actuator assembly which is designed to move the material dispensing unit over a work surface in order to deposit the building material layer by layer in predetermined print paths; and
at least one control unit for controlling the actuator assembly,
wherein the device is configured to carry out the method with the steps according to one of the preceding claims in such a way that the control unit is able to control the actuator assembly first for the layer-by-layer deposition of the building material for at least two print path layers of the first of the at least two component portions adjacent to one another, and subsequently for the layer-by-layer deposition of the building material for at least one print path layer of the adjacent second of the at least two component portions adjacent to one another.

17. The device according to claim 16,
wherein the device furthermore comprises a planning unit for planning at least one connection region of the at least two component portions adjacent to one another; and
wherein the planning unit is configured to plan the at least one upper print path portion and the at least one lower print path portion of the at least two print path layers, layered on top of one another, of the first component portion, which are to be layered on top of one another with a horizontal offset to one another, in such a way that, when viewed in a cross-section of the at least one connection region, they define a first connection contour that deviates from a normal the work surface.

18. The device according to claim 16,
wherein the planning unit is designed as an integral part of the control unit or as a separate unit, which is in direct or indirect communicative connection with the control unit.

19. The device according to claim 16,
wherein the planning unit can be configured to analyze an outer geometry of the material dispensing unit on the basis of data or signals provided by at least one sensor and/or by the material dispensing unit and/or a database and/or through manual input by a user,
wherein the planning unit is in particular configured, on the basis of a proximal end of the material output,
to determine a printing normal to the work surface that passes through a dispensing opening at the proximal end of the material dispensing unit,
to determine a virtual printing line of the material dispensing unit, which is applied to the outer geometry of the material dispensing unit, starting from a virtual center of rotation on a radial outer edge of the proximal end of the material dispensing unit, and
to ascertain at least one virtual printing angle, which is enclosed by the printing normal to the work surface and the virtual printing line,
wherein the planning unit in communicative connection is in direct or indirect communicative connection with a sensor unit and/or an input unit for manual input.

20. (canceled)

21. The device according to claim 16,
wherein the device comprises a database for providing specific information on the material dispensing unit, on the basis of which the device can analyze the outer geometry of the material dispensing unit.

22. The device according to claim 16,
wherein the control unit is in communicative connection with at least one sensor unit of the device in order to control the actuator assembly and optionally the material dispensing unit on the basis of information from the sensor unit,
wherein the sensor unit comprises at least one of the following sensors: mechanical sensor, optical sensor, optical recording device, capacitive sensor, inductive sensor.

23-25. (canceled)
